(19) United States
(12) Patent Application Publication
(10) Pub. No.: US 2012/0281252 A1
(43) Pub. Date: Nov. 8, 2012

(54) DISTRIBUTED PRINTING SYSTEM AND METHOD

(75) Inventor: WEI-YU CHEN, Santa Clara, CA (US)

(73) Assignee: HON HAI PRECISION INDUSTRY CO., LTD., Tu-Cheng (TW)

(21) Appl. No.: 13/450,583

(22) Filed: Apr. 19, 2012

(30) Foreign Application Priority Data
May 5, 2011 (TW) 100115778

(51) Int. Cl. G06F 3/12; G06K 15/02

(52) U.S. Cl. 358/1.15

(57) ABSTRACT

System and method of distributing a single print job to multiple printers are disclosed. The distributed printing system includes a master printer for receiving a print job from a computing device and generating a plurality of child print jobs based on the print job and a plurality of slave printers in communication with the master printer via a network. The master printer is adapted to transmit the child print jobs to the slave printers. The slave printers are adapted to process the of child print jobs into processed child print jobs and send the processed child print jobs back to the master printer. The master printer is adapted to assemble the processed child print jobs into a final print job and transmit the final print job to one of the slave printers to perform the final print job.

### BACKGROUND

1. Technical Field

The disclosure generally relates to a distributed printing system and a distributed printing method for distributing a single print job to multiple printers.

2. Description of Related Art

Multi-function printers (MFPs) including scanner units, printer units and facsimile units are popularly used because the MFPs are relatively small in size, having low noise and may perform color copying, printing, scanning, and facsimile transmission at low cost. In a print process, a document firstly needs to be converted to printable data before the document can be printed. However, it may take a lot of time to convert the document to such a data format, especially if the document contains many pages. Therefore, there is a need for a technique for distributing a print job to a plurality of printers to process portions of printed jobs in parallel within a short period of time.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional block diagram of a multi-function printer (MFP) which is an example of a master printer according to one embodiment.

FIG. 2 is a view illustrating one example of a structure of a distributed printing system according to one embodiment.

FIG. 3 is a flowchart showing one embodiment of a method for distributing a print job using the distributed printing system of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media comprise CDs, DVDs, BLU-RAY, flash memory, and hard disk drives.

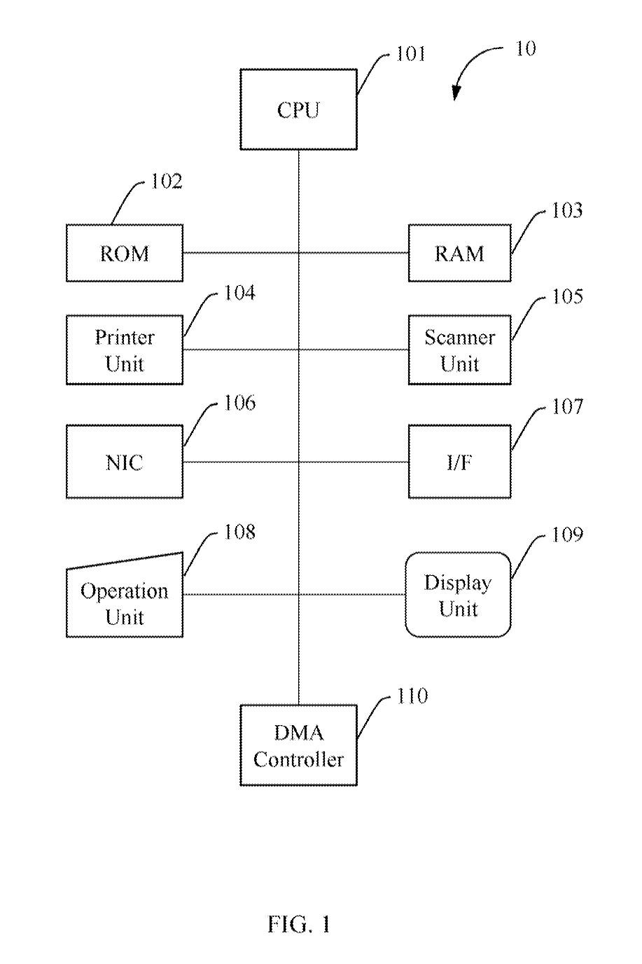

FIG. 1 is a functional block diagram of a multi-function printer (MFP) 10 which is an example of a master printer according to one embodiment. The MFP 10 comprises a central processing unit (CPU) 101, a read only memory (ROM) 102, a random access memory (RAM) 103, a printer unit 104, a scanner unit 105, a network interface controller (NIC) 106, an interface (I/F) 107, an operation unit 108, a display unit 109, and a direct memory access (DMA) controller 110.

The CPU 101 is a processor for controlling the MFP 10 overall. The MFP 10 is controlled by running one or more programs (firmware) stored in the ROM 102.

The ROM 102 is non-volatile memory for storing the program for controlling the MFP 10.

The RAM 103 is volatile memory which is used as a working area when the CPU 101 runs the program stored in the ROM 102.

The printer unit 104 may print image data or facsimile data on a sheet of paper, an overhead projector (OHP) sheet, or the like (hereinafter, these will be referred to generically as a “printing medium”). In one embodiment, the printer unit 104 is an inkjet printer which comprises a printhead, a motor, and an ink cartridge. The printer unit 104 causes the ink carriage in the printhead to scan on the printing medium in a reciprocating manner, and to apply ink to the printing medium. Printing is performed by transporting the printing medium according to the scanning perpendicularly to the scanning direction of the carriage.

The scanner unit 105 may scan an image on a sheet of paper, a plastic sheet, a film, or any flat surface, and generate image data. The scanner unit 105 temporarily buffers, in the RAM 103, image data that has been generated by scanned images.

The scanner unit 105 may comprise a scanner head which has a scanning width corresponding to an overall width of a largest readable medium (for example, A4-size paper). In the scanner head, a plurality of charge-coupled devices (CCDs) or a plurality of CMOS image sensors (CISs) may be arranged in the scanner head, in a line along the scanning width direction. Image data is obtained by the plurality of CCDs detecting light from the image, and converting the detected light into electrical signals. Further, the scanner head may be mechanically moved along a linear direction in a stepwise fashion by a motor of the scanner unit 105, with the linear direction being perpendicular to the line of the plurality of CCDs. An entire image is scanned by a combination of an electrical scanning of the plurality of CCDs and a mechanical movement of the scanner head. In the present disclosure, a direction of the electrical scanning performed by the line of the plurality of CCDs at any one time is called a “main scanning direction”, and the direction of the mechanical movement of the scanner head is called a “sub scanning direction.”

As described above, the scanner unit 105 may scan an image line-by-line, and may generate color image data. The color image data is image data in which the color components including red, green, and blue (RGB) components are represented in, for example, 8 bits (0 to 255). A number of bits representing each pixel can be freely set within a capability range of the plurality of CCDs or the plurality of CISs. The number of bits representing each pixel is called “image level” or “color depth.”

The NIC 106 may be a network adapter card using a specific physical layer, or and standard data link layer such as Ethernet or Wi-Fi. When used in a WAN networking environment, the MFP 10 typically comprises a modem or other means for establishing communications over the WAN, such as the Internet.

The I/F 107 is an interface for allowing the MFP 10 to communicate with various external devices. The external devices may comprise, for example, a personal computer (PC), and a drive for reading and writing data in a storage medium such as a memory card. The I/F 107 may comprise USB and IEEE 1394.

The operation unit 108 may be operated by a user to provide the MFP 10 with various instructions. An instruction may comprise, for example, a scan instruction for causing the scanner unit 105 to perform scanning, and a print instruction for causing the printer unit 104 to perform printing on a printing medium. The instruction to the MFP 10 may be provided from a PC, or the like, through the I/F 107.

The display unit 109 may notify the user of various information, and comprises an LCD, an LED, or the like. The various information provided to the user may comprise, for example, a state of the MFP 10 (scanning, printing, faxing, or idling), and a setting menu of the MFP 10.

The DMA controller 110 is a controller for transferring data between constituent elements of the MFP 10.

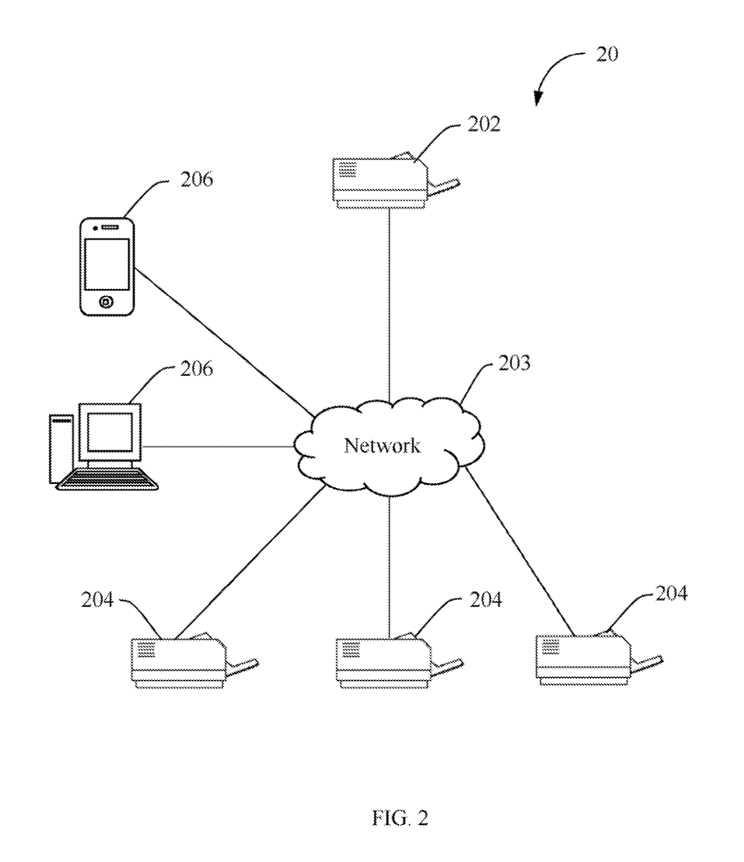

FIG. 2 illustrates one example of a structure of a distributed printing system 20 according to one embodiment. The distributed printing system 20 may include a master printer 202 in the form of the MFP 10 and a plurality of slave printers 204. The master printer 202 may communicate with the plurality of slave printers 204 through a network 203. The network 203 may be a local area network (LAN) or a wide area network (WAN). The master printer 202 may receive a print job from a computing device 206. The computing device 206 may be any one of general purpose computers, such as a desktop computer, a notebook computer or a smart phone.

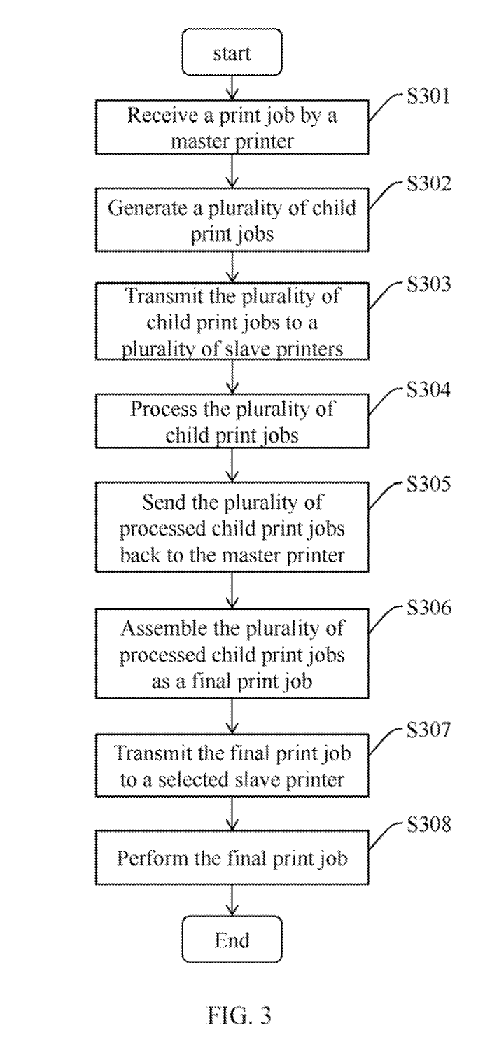

FIG. 3 is a flowchart showing one embodiment of a method for distributing a print job to multiple printers using the distributed printing system of FIG. 2. The method may comprise the following steps.

In step S301, the master printer 202 receives a print job from the computing device 206 through the network 203. The print job includes a document to be printed. The document is in an image data format.

In step S302, the master printer 202 generates a plurality of derivative print jobs (child print jobs) based on the print job. The print job can be divided according to the pages of the document included therein. For example, the master printer 202 can break down the document into a plurality of child documents each of which contains an equal number of pages. Each of the plurality of child print jobs includes one of the plurality of child documents.

In step S303, the master printer 202 transmits the plurality of child print jobs to the plurality of slave printers 204. If the number of the plurality of child print jobs is equal to the number of the plurality of slave printers 204, the master printer 202 transmits the plurality of child print jobs to the plurality of slave printers 204 on a one-to-one basis. If the number of the plurality of child print jobs is less than the number of the plurality of slave printers 204, the master printer 202 selects some of the plurality of slave printers 204 and transmits the plurality of child print jobs to the selected slave printers 204 on a one-to-one basis. If the number of the plurality of child print jobs is more than the number of the plurality of slave printers 204, the master printer 202 transmits the plurality of child print jobs to the plurality of slave printers 204 respectively according to each work load of the plurality of slave printers 204.

In step S304, the plurality of slave printers 204 process the plurality of child print jobs into a plurality of processed child print jobs by converting each of the plurality of child documents into a printable data formatted document, such as a raster data formatted document. The raster data formatted documents converted by the plurality of slave printers 204 are ready to be printed by a printer without any further processing.

In step S305, the plurality of slave printers 204 transmits the plurality of processed child print jobs, each of which includes a raster data formatted document, back to the master printer 202.

In step S306, the master printer 202 assembles the processed child print jobs and generates a final print job by assembling all the raster data formatted documents into a final raster data formatted document.

In step S307, the master printer 202 select a slave printer from the plurality of slave printers 40 and transmits the final print job including the final raster data formatted document to the slave printer.

In step S308, the slave printer performs the final print job and prints the final raster data formatted document.

Although numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. The description and the claims drawn for or in relation to a method may comprise some indication in reference to certain steps. However, any indication used is only to be viewed for identification purposes and not as a suggestion as to an order for the steps.

What is claimed is:

1. A distributed printing system, comprising:
a master printer adapted to receive a print job from a computing device and generate a plurality of child print jobs based on the print job;
a plurality of slave printers, each of the plurality of slave printers is in communication with the master printer via a network;
wherein the master printer is further adapted to transmit the plurality of child print jobs to the plurality of slave printers, the plurality of slave printers are adapted to process the plurality of child print jobs into a plurality of processed child print jobs and send the plurality of processed child print jobs back to the master printer, the master printer is further adapted to assemble the plurality of processed child print jobs into a final print job and transmit the final print job to one of the plurality of slave printers to perform the final print job.

2. The distributed printing system of claim 1, wherein the master printer is further adapted to broadcast a message to notify the computing device of master printer information via the network.

3. The distributed printing system of claim 1, wherein the print job comprises a document in a format of image data, the master printer is further adapted to break down the document into a plurality of child documents and transmit the plurality of child documents to the plurality of slave printers.

4. The distributed printing system of claim 3, wherein the plurality of slave printers are further adapted to convert the plurality of child documents to a plurality of processed child documents in a printable data format and send the plurality of processed child documents back to the master printer.

5. The distributed printing system of claim 4, wherein the master printer is further adapted to assemble the plurality of processed child documents into a final document and transmit the final document to a selected slave printer, the selected slave printer is adapted to print the final document.

6. A distributed printing method, comprising:
providing a master printer and a plurality of slave printers, each of the plurality of slave printers is in communication with the master printer via a network;
receiving a print job from a computing device by the master printer;
generating a plurality of child print jobs based on the print job;
transmitting the plurality of child print jobs to the plurality of slave printers;
processing the plurality of child print jobs into a plurality of processed child print jobs by the plurality of slave printers;
sending the plurality of processed child print jobs back to the master printer,
assembling the plurality of processed child print jobs into a final print job by the master printer;
transmitting the final print job to a selected slave printer; and
performing the final print job by the selected slave printer.

7. The distributed printing method of claim 6, further comprising broadcasting a message to notify the computing device of master printer information via the network.

8. The distributed printing method of claim 6, wherein the print job comprises a document in a format of image data, the method further comprising breaking down the document into a plurality of child documents and transmitting the plurality of child documents to the plurality of slave printers.

9. The distributed printing method of claim 8, further comprising converting the plurality of child documents to a plurality of processed child documents in a printable data format by the plurality of slave printers, and sending the plurality of processed child documents back to the master printer.

10. The distributed printing method of claim 9, further comprising assembling the plurality of processed child documents into a final document by the master printer and transmitting the final document to a selected slave printer to print the final document.

11. A printer in communication with a plurality of slave printers via a network, the printer comprising:
a storage system;
at least one processor;
one or more programs being stored in the storage system and executable by the at least one processor, wherein the one or more programs, when executed, are adapted to cause the printer to receive a print job from a computing device, generate a plurality of child print jobs based on the print job, transmit the plurality of child print jobs to the plurality of slave printers, receive a plurality of processed child print jobs processed by the plurality of slave printers, assemble the plurality of processed child print jobs into a final print job, and transmit the final print job to a selected slave printer to perform the final print job.

12. The printer of claim 11, wherein the one or more programs are further adapted to cause the printer to broadcast a message to notify the computing device of master printer information via the network.

13. The printer of claim 11, wherein the print job comprises a document in a format of image data, the one or more programs are further adapted to cause the printer to break down the document into a plurality of child documents and transmit the plurality of child documents to the plurality of slave printers.

14. The printer of claim 13, wherein the one or more programs are further adapted to cause the printer to receive a plurality of processed child documents in a format of printable data from the plurality of slave printers.

15. The printer of claim 14, wherein the one or more programs are further adapted to cause the printer to assemble the plurality of processed child documents into a final document and transmit the final document to a selected slave printer to print the final document.
